(19) United States
(12) Patent Application Publication
(10) Pub. No.: US 2019/0364853 A1
(43) Pub. Date: Dec. 5, 2019

(54) Method and System for Protecting Apiaries by Means of Thermal and Moisture Membranes

(71) Applicants: Steven Allen Voisin, Suttons Bay, MI (US); William Robert Thomas, Vanderbilt, MI (US); Gregory Michael Rohrbach, Vanderbilt, MI (US)

(72) Inventors: Steven Allen Voisin, Suttons Bay, MI (US); William Robert Thomas, Vanderbilt, MI (US); Gregory Michael Rohrbach, Vanderbilt, MI (US)

(21) Appl. No.: 15/932,979

(22) Filed: Jun. 4, 2018

(51) Int. Cl. A01K 47/06; A01K 47/02

(52) U.S. Cl. CPC A01K 47/06; A01K 47/02

(57) ABSTRACT

A method and system for protecting apiaries by means of thermal and moisture membranes. The invention being comprised of one-piece, rigid, yet foldable, modular units. Said thermal and moisture membranes being configured in such a manner as to keep a hive dry, insulate a hive in cold climates and reflect radiant heat back into a hive. Conversely, said membrane also moderating heat in the summer by reflecting thermal radiation. The membranes also minimizing the growth of pathogens and bacteria within a hive. An object of the invention being to promote the health of anthophila broods therein.

### FIELD OF THE INVENTION

The invention relates to apiaries. More specifically, it relates to methods and systems for protecting apiaries.

### BACKGROUND

Apiaries, more commonly referred to as beehives, have been in existence for hundreds of years. The first apiaries were comprised of simple baskets called ‘skeps.’ Loranzo Langstroth developed the first mobile apiary in the mid 1800s. British beekeepers later standardized honeycomb frames for apiaries in the 1880s. As bees became popular for pollinating crops in the early 1900s, the ‘National’ hive was introduced and was commonly used due to its affordability. With the emergence of plastic compounds in mid 1900s, beekeepers began incorporating such materials in hives to provide insulation and protect them from the elements. U.S. Pat. No. 8,814,630B2 granted to Rittberger disclosed a beehive constructed of PVC folding plastic; however, it did not include multiple membranes within the walls. U.S. Patent No. 20100022161A1 granted to Shtatnov disclosed apiary walls that included metallic insulation but were not foldable. International Patent No. WO2017158400 (Al) granted to Hassan disclosed a light-proof and windproof hive but it was not foldable. While several apiaries contain plastics to mitigate the effects of climate, none were found that combined foldability with reflective, waterproof membranes.

### SUMMARY OF THE INVENTION

The device herein disclosed and described provides a solution to the shortcomings in the prior art through the disclosure of a method and system for protecting apiaries by means of thermal and moisture membranes. An object of the invention is to increase the yield of apiaries. By more effectively winterizing a hive, bee farmers can decrease brood morbidity rates leading to overall increased yields.

Another object of the invention is to provide a means to prevent moisture from migrating into an apiary. The walls of the brood chambers are sealed in an impermeable membrane that prevents moisture from entering the chambers and rotting internal components such as the wood frames etc.

Another object of the invention is to provide a means to insulate an apiary. The interior portions of the brood chambers are encased in thermal insulation that allow heat generated from the brood to remain inside the chamber. This insulation also maintains hive temperature by reflecting heat back toward a brood.

Another object of the aforementioned invention is to prevent pathogens from growing within a hive. Anthophila inside a hive can generate both heat and humidity. This humidity can be problematic if it condensates on cool surfaces because it can activate pathogens such as fungi and bacteria. Within the invention, an air gap is formed between the wall substrate and the insulator. This air gap mediates the temperature between the outside surface and the inside surface of the chamber and prevents condensation from forming on internal structures, thereby limiting pathogenic growth.

Another object of the aforementioned invention is to provide a means to allow for cooling of an apiary in the heat of summer. When temperatures of a hive become to high, bees halt production and exit until it cools—this exodus is known as “bearding a hive.” In order to prevent bearding, the exterior (particularly the top) is layered in a light-colored polyvinyl chloride (PVC) membrane. This membrane allows for a significant reduction in heat absorption when compared to conventional hive coatings.

Another object of the aforementioned invention is to provide a means to allow for easy assembly of an apiary. The rigid yet flexible, single-piece, plastic substrate allows a user to quickly assemble a hive. A heat gun is used to bond each end together and assembly time is significantly less than traditional hives.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of a folded assembly embodiment the invention.

FIG. 2 shows a section view of a folded assembly embodiment of the invention.

FIG. 3 shows a side view of an single, unfolded member embodiment of the invention.

FIG. 4 shows a side view of an single, unfolded member embodiment of the invention.

FIG. 5 shows a closeup sectional view of a corner of a folded assembly embodiment.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

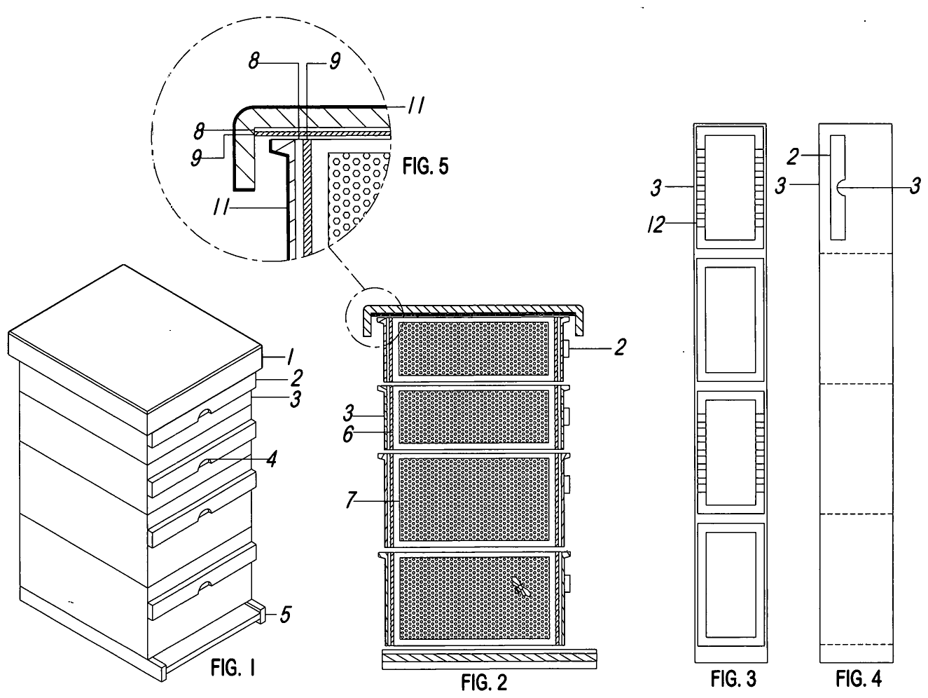

FIG. 1 shows a perspective view of a folded assembly embodiment the invention comprised of a plurality of cube-shaped panels made of a rigid material such as, but not limited to: plastic, metal and the like and being formed from planar, brood chamber wall 3. Each said brood chamber wall 3 having to top and bottom member and allowed to stack on top of one another with base 5. In addition, each brood chamber may have a handle 2 and a cover 1 thereon.

FIG. 2 shows a section view of a folded assembly embodiment of the invention with brood chamber walls 3 configured to receive a plurality of honeycomb frames 7 therein.

FIG. 3 shows a side view of a single, unfolded member embodiment of the invention. The figure showing brood chamber wall 3 being rectangular-shaped, planar member having a raised rail with slots adapted to receive said honeycomb frames 7 therein.

FIG. 4 shows a side view of an single, unfolded member embodiment of the invention with rectangular-shaped handles 2 thereon.

FIG. 5 shows a closeup, sectional view of a corner of a folded assembly embodiment having brood chamber walls with moisture barrier 11 comprised of PVC-type material such as, but not limited to, Sarnafil™ and the like being affixed to said substrates by adhesives. An inner portion of said substrates having an insulation 9 comprised of a material such as, but not limited to, Refletix™ and the like with air gap 8 thereinbetween.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

1. A folding apiary, comprising:
a.) cube-shaped modules with bottom wall, sidewall and top wall, the walls being assembleable to define an interior compartment and being disassembleable to lie flat;
b.) rigidizing structure incorporated with the sidewall to render the assembled container self supporting, and wherein each wall defines an inner surface;
c.) a first moisture barrier fixedly connected to the exterior of the sidewall;
d.) a second radiant energy reflective layer defining one of the inner surfaces;
d.) a third air trapping thermal insulation gap there between sidewall and reflective layer.

2. The folding apiary of claim 1 wherein the moisture barrier is comprised of a PVC-type material.

3. The moisture barrier of claim 2 being fixedly connected to the sidewall by means of an adhesive.

4. The radiant energy reflective layer of claim 1 comprised of a plastic-like material having a bottom wall, sidewall and top wall, the walls being assembleable to define and interior compartment and being disassembleable to lie flat.

5. The folding apiary of claim 1 having at least two side wall interiors with notches perpendicular to side wall's longitudinal axis and configured to receive brood chamber frames.

6. The folding apiary of claim 1 having at least one exterior side wall with a rectangular, handle portion, parallel to side wall's longitudinal axis and configured to receive a users hand.
